(19) United States
(12) Patent Application Publication
(10) Pub. No.: US 2026/0213545 A1
(43) Pub. Date: Jul. 23, 2026

(54) SYSTEM AND METHOD FOR COORDINATED FREQUENCY RESPONSE OF AN INVERTER-BASED RESOURCE TO GRID FREQUENCY CHANGES

(71) Applicant: General Electric Renovables España, S.L., Barcelona (ES)

(72) Inventors: Dustin F. Howard, Brookhaven, GA (US); Patrick Osae Djan-Sampson, Niskayuna, NY (US); Alfredo Sebastian Achilles, Niskayuna, NY (US)

(21) Appl. No.: 19/140,083

(22) PCT Filed: Dec. 19, 2022
(86) PCT No.: PCT/US2022/053307

§ 371 Date: Jun. 17, 2025

(51) Int. Cl. H02J 3/38; F03D 7/02; G05B 13/02; H02J 3/0014; H02J 3/48; H02J 101/28

(52) U.S. Cl. CPC H02J 3/381; F03D 7/0284; G05B 13/026; H02J 3/00142; H02J 3/48; F05B 2270/1033; H02J 2101/28

(57) ABSTRACT

A system and method operate a renewable energy source having an inverter-based resource (IBR) system and controlled by a power converter controller. The IBR system is operated in grid-forming mode (GFM) control. The power converter controller receives a control signal that is derived based on a frequency droop function performed on a detected grid frequency at an upstream controller. The power converter controller generates an output power actuator signal based on a frequency droop function performed on the detected grid frequency at the power converter controller. A first compensation is applied to the upstream controller that reduces or eliminates changes in the control signal received by the power converter controller due to changes in the grid frequency.

The present disclosure relates generally to operation of an inverter-based resource (IBR), such as a wind turbine generator, and more particularly, to systems and methods for controlling the IBR response to a change in grid frequency.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is typically geared to a generator for producing electricity.

Wind turbines can be distinguished in two types: fixed speed and variable speed turbines. Conventionally, variable speed wind turbines are controlled as current sources connected to a power grid. In other words, the variable speed wind turbines rely on a grid frequency detected by a phase locked loop (PLL) as a reference and inject a specified amount of current into the grid. The conventional current source control of the wind turbines is based on the assumptions that the grid voltage waveforms are fundamental voltage waveforms with fixed frequency and magnitude and that the penetration of wind power into the grid is low enough so as to not cause disturbances to the grid voltage magnitude and frequency. Thus, the wind turbines simply inject the specified current into the grid based on the fundamental voltage waveforms. However, with the rapid growth of wind power systems, penetration into some grids has increased to the point where wind turbine generators have a significant impact on the grid voltage and frequency. When wind turbines are located in a weak grid, wind turbine power fluctuations may lead to an increase in magnitude and frequency variations in the grid voltage. These fluctuations may adversely affect the performance and stability of the PLL and wind turbine current control.

In addition, the reduction in the proportion of synchronous machines with respect to asynchronous machines, which determine the grid defining parameters voltage and frequency, have contributed to decreasing stability margins. The immediate consequence of the decreased stability margins is a grid collapse when subjected to voltage and frequency disturbances in the grid. To address this, many renewable resource machines, such as an inverter-based resource (IBR) configured as a doubly-fed induction generator in a wind turbine power system, operate in a “grid forming mode.”

In “grid-forming mode” (GFM), the converters provide a voltage-source characteristic, where the angle and magnitude of the voltage are controlled to achieve the regulation functions needed by the grid. In GFM operation, the renewable resource may be controlled to be operate as a virtual synchronous machine (VSM) having an inertial power regulator replicating synchronous machine behavior. Similar to an actual synchronous machine, this control exhibits an inertial response. Also, in GFM mode control, the predominant system variables of frequency and terminal voltage magnitude are regulated. With this structure, current will flow according to the demands of the grid while the converter contributes to establishing a voltage and frequency for the grid. This characteristic is comparable to conventional generators based on a turbine driving a synchronous machine.

The basic control structure to achieve the above grid-forming objectives was developed and field-proven for battery systems in the early 1990's (see e.g., U.S. Pat. No. 5,798,633 entitled “Battery Energy Storage Power Conditioning System”). Applications to full-converter wind generators and solar generators are disclosed in U.S. Pat. No. 7,804,184 entitled “System and Method for Control of a Grid Connected Power Generating System,” and U.S. Pat. No. 9,270,194 entitled “Controller for controlling a power converter.” Applications to grid-forming control for a doubly-fed wind turbine generator are disclosed in PCT/US2020/013787 entitled “System and Method for Providing Grid-Forming Control for a Double-Feb Wind Turbine Generator.”

To be effective, GFM inverter-based resources (IBRs) must be able to maintain an internal voltage phasor that does not move quickly when there are changes in grid conditions, e.g., sudden addition/removal of loads, opening or closing of grid connections that lead to phase jumps and/or rapid change of frequency. Such events include, for example, low voltage ride through (LVRT), high voltage ride through (HVRT), multiple fault ride through (MFRT), and phase jump events. In other words, the power from the GFM resource must be able to change suddenly to stabilize the grid, with a subsequent slow reset to power being commanded from a higher-level control function.

Grid-forming (GFM) IBRs inherently support grid frequency and angle stability in a similar way as synchronous machines. Therefore, a GFM IBR automatically changes power output to stabilize the grid with negligible time delays and without deadbands. However, one side effect of this inherent characteristic of GFM resources is that upstream power regulating functions (e.g., higher-level controls) of the grid-forming resource may counteract this inherent response if not properly designed to avoid such counteraction.

Thus, a method and system are needed for compensating upstream power regulating functions in a plant operating GFM IBRs in such a way to avoid counteracting the inherent power response of the GFM IBR.

### BRIEF DESCRIPTION

Aspects and advantages of the invention will be set forth in part in the following description, or may be obvious from the description, or may be learned through practice of the invention.

The present disclosure relates to a method and system for operating a renewable energy source having an inverter-based resource (IBR) system (which may be connected to a power grid or an islanded system) and controlled by a power converter controller. The method includes: operating the IBR system in grid-forming mode (GFM) control; with the power converter controller, receiving a control signal that is derived in part based on one of an inertial power regulator or a frequency droop function performed on a detected grid frequency at an upstream controller; with the power converter controller, generating an output power actuator signal based in part on a frequency droop function performed on the detected grid-grid frequency at the power converter controller; and applying a first compensation to the upstream controller that reduces or eliminates changes in the control signal received by the power converter controller due to changes in the grid frequency.

In a particular embodiment, the IBR is a wind turbine generator, the upstream controller is a wind turbine controller, and the control signal received by the power converter controller is a power reference signal generated by the wind turbine controller. In this embodiment, the first compensation may be provided by a turbine-level power command compensation based on the detected grid frequency and a generator rotor speed feedback signal.

In an alternate embodiment of the wind turbine configuration, the first compensation may be provided by a turbine-level power or speed feedback compensation based on a wind turbine power feedback signal and the detected grid frequency.

In still another embodiment of the wind turbine configuration, the first compensation may be provided by the turbine-level power command compensation and the turbine-level power or speed feedback compensation.

In yet another embodiment wherein the IBR is a wind turbine generator, and the control signal is a power reference signal generated by the wind turbine controller, the upstream controller may be a plant level controller that generates a power limit signal received by the wind turbine controller, the power-limit signal used by the wind turbine controller to generate the power reference signal. In this embodiment, the first compensation may be provided by a plant-level power command compensation based on the detected grid frequency. The plant-level power command compensation may also be based on an aggregated response estimation signal generated that predicts a collective response in active power of a group of the wind turbine generators in a plant to grid frequency changes.

In an alternative embodiment wherein the upstream controller is the plant level controller, the first compensation may be provided by a plant-level power feedback compensation based on a plant power feedback signal and the detected grid frequency. The plant-level power feedback compensation may also be based on the aggregated response estimation signal.

In still another embodiment wherein the upstream controller is the plant level controller, the first compensation may be provided by a signal derived from rate-of-change of the detected grid frequency and applied to a plant power regulator in the plant level controller.

In still a further embodiment wherein the upstream controller is the plant level controller, the first compensation may be provided by any one or combination of: (a) the plant-level power command compensation based on the detected grid frequency; (b) a plant-level power feedback compensation based on a plant power feedback signal and the detected grid frequency; or (c) a signal derived from rate-of-change of detected grid frequency and applied to a plant power regulator in the plant level controller.

The invention also encompasses a method for operating a wind turbine generator in a wind turbine plant having a plurality of the wind turbines connected to a power grid, the wind turbines having a wind turbine controller in communication with a plant-level controller, and the wind turbine generator having a power converter controller. The method includes: operating the wind turbine generator in grid-forming mode (GFM) control; with the power converter controller, receiving a first control signal derived by the wind turbine controller based on one of an inertial power regulator or a frequency droop function performed on a detected grid frequency by the wind turbine controller; with the wind turbine controller, receiving a second control signal derived by the plant-level controller based on a frequency droop function performed on the detected grid frequency by the plant level controller; with the power converter controller, generating an output power actuator signal based on a frequency droop function performed on the detected grid frequency by the power converter controller; and applying a first compensation to the wind turbine controller, and applying a second compensation to the plant-level controller, wherein the first and second compensations reduce or eliminate changes in the control signal received by the power converter controller due to changes in the grid frequency.

The present invention also encompasses a wind turbine that includes a wind turbine generator configured as an inverter-based resource (IBR) renewable energy source connected to a power grid and controlled by a power converter controller. The wind turbine generator is configured for operation in accordance with any combination of the method embodiments discussed above.

The present invention also encompasses a wind turbine plant having a plurality of wind turbines. Each of the wind turbines a wind turbine generator configured as an inverter-based resource (IBR) connected to a power grid and controlled by a power converter controller. One or more of the wind turbine generators are configured for operation in accordance with any of the method embodiments discussed above.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic diagram of one embodiment of a main circuit of a grid-forming system;

FIG. 2 illustrates a control diagram for providing grid-forming mode (GFM) control according to conventional construction;

FIG. 3 illustrates a perspective view of one embodiment of a wind turbine according to the present disclosure;

FIG. 4 illustrates a simplified, internal view of one embodiment of the nacelle of the wind turbine shown in FIG. 3;

FIG. 5 illustrates a schematic diagram of one embodiment of a wind turbine power system in accordance with aspects of the present disclosure;

FIG. 6 illustrates a wind farm utilizing a plurality of the wind turbine power systems of FIG. 5;

FIG. 7 illustrates a block diagram of one embodiment of suitable components that may be included within a controller used as a converter controller, a turbine controller, or a farm-level controller;

FIG. 8 illustrates a system for providing grid-forming control of a double-fed generator of a wind turbine;

FIG. 9 illustrates an expanded block diagram of an inertial power regulator with frequency droop control;

FIG. 10 illustrates a simplified block diagram of the main inputs and outputs of a turbine controller;

FIG. 11 illustrates a flow chart of a method embodiment in accordance with objectives of the present disclosure;

FIG. 12 illustrates a system embodiment that utilizes plant-level and/or turbine-level compensation in accordance with aspects of the present disclosure;

FIG. 13 illustrates a more detailed view of the turbine-level compensation functionality; and

FIG. 14 illustrates a more detailed view of the plant-level compensation functionality.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to systems and methods for controlling an inverter-based resource (IBR) connected to a power grid, wherein the IBR is operated in grid-forming mode (GFM) as a virtual synchronous machine (VSM). As used herein, inverter-based resources generally refer to electrical devices that can generate or absorb electric power through switching of power-electronic devices.

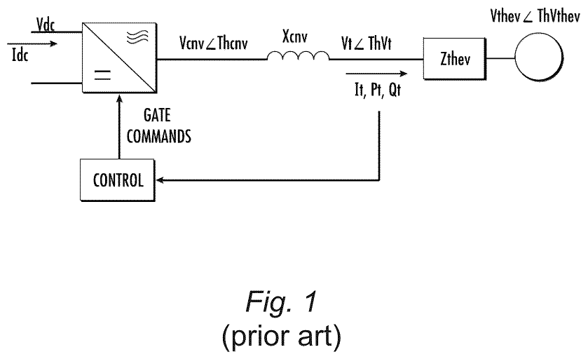

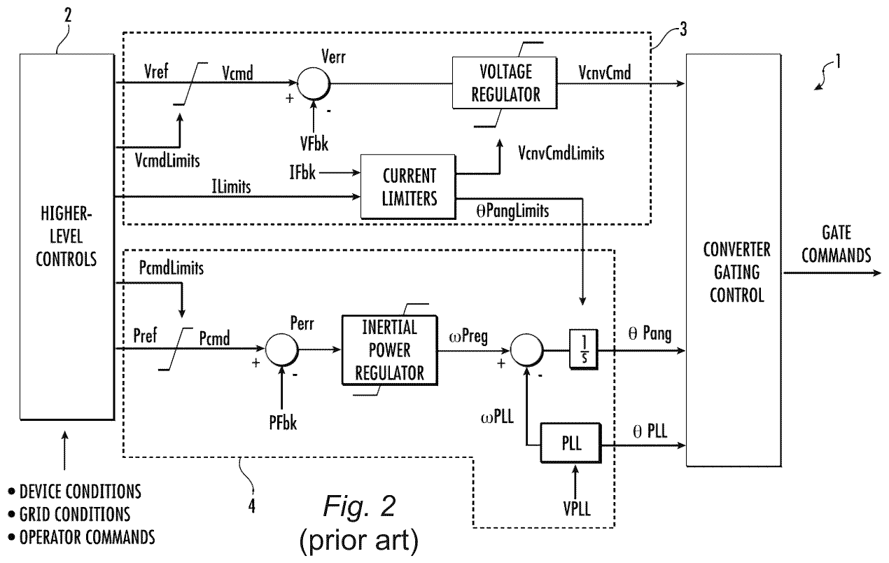

A general description of the control and operation of an IBR operated in GFM is provided below with reference to FIGS. 1-2.

FIG. 1 is a schematic diagram of one embodiment of a main circuit of a grid-forming system. As shown, the main circuit includes a power-electronic converter with connections on DC and AC sides. This converter receives gating commands from a controller that creates an AC voltage phasor Vcnv at an angle of Thvenv. The angle is with respect to a reference phasor having a fixed frequency. The DC side is supplied with a device capable of generating or absorbing power for even a short duration. Such devices may include, for example, batteries, solar panels, rotating machines with a rectifier, or capacitors. In addition, as shown, the circuit includes an inductive impedance Xcnv connecting the converter to its point of interconnection, shown as the voltage Vt and angle ThVt in FIG. 1. The electrical system behind the point of interconnect is shown as a Thevenin equivalent with impedance Zthev and voltage Vthev at angle ThVthev. This equivalent can be used to represent any circuit, including grid-connected and islanded circuits with loads. In practical situations, the impedance Zthev will be primarily inductive.

Still referring to FIG. 1, the closed-loop portion of the main control receives feedback signals from the voltage and current at the point of interconnection. Additional inputs are received from higher-level controls (not shown). While FIG. 1 illustrates a single converter as an example, any grouping of equipment that can create an electrical equivalent of a controlled voltage Vcnv behind an impedance Xcnv can have the control schemes disclosed applied to achieve the same performance benefits.

Referring now to FIG. 2, a control diagram for providing grid-forming mode (GFM) control according to conventional construction is illustrated. As shown, a converter controller 1 receives references (e.g., Vref and Pref) and limits (e.g., VcmdLimits and PcmdLimits) from higher-level controls 2. These high-level limits are on physical quantities of voltage, current, and power. The main regulators include a fast voltage regulator 3 and a slow power regulator 4. These regulators 3, 4 have final limits applied to the converter control commands for voltage magnitude (e.g., VcnvCmd) and angle (e.g., θ_{Pang} and θ_{PLL}) to implement constraints on reactive-and real-components of current, respectively. Further, such limits are based upon a pre-determined fixed value as a default, with closed-loop control to reduce the limits should current exceed limits.

Grid-forming converter technology responds to changes in system generation/load in a similar way as conventional (e.g., thermal) generation. Similar to conventional thermal generation, frequency droop is used in grid-forming converters to share loading among other parallel connected grid-forming resources. Unlike conventional power generation, however, the amount of power available from wind-turbines is less predictable due to variations in wind. The amount of support to system frequency in terms of active power is therefore constrained by local wind conditions.

As mentioned above, an inherent characteristic of GFM IBRs is that they inherently support grid frequency and angle stability in a similar way as synchronous machines. A GFM IBR automatically changes power output to stabilize the grid with negligible time delays and without deadbands. The upstream (higher-level) power regulating control functions, however, tend to counteract this inherent response. An aim of the present methodology is to minimize this disadvantageous counter effect.

As used herein, inverter-based resources (IBR) generally refer to electrical devices that can generate or absorb electric power through switching of power-electronic devices. Accordingly, inverter-based resource may include wind turbine generators, solar inverters, energy-storage systems, STATCOMs, or hydro-power systems. For example, in one embodiment, the inverter-based resource may be a wind turbine power system having a rotor-side converter, a line-side converter, and a doubly-fed induction generator (DFIG) connected to the electrical grid.

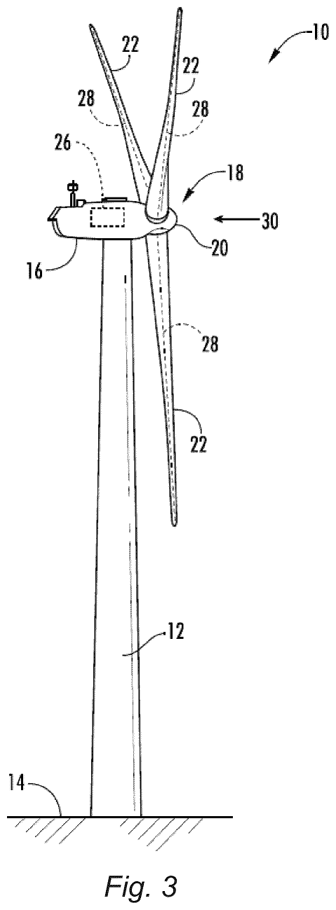

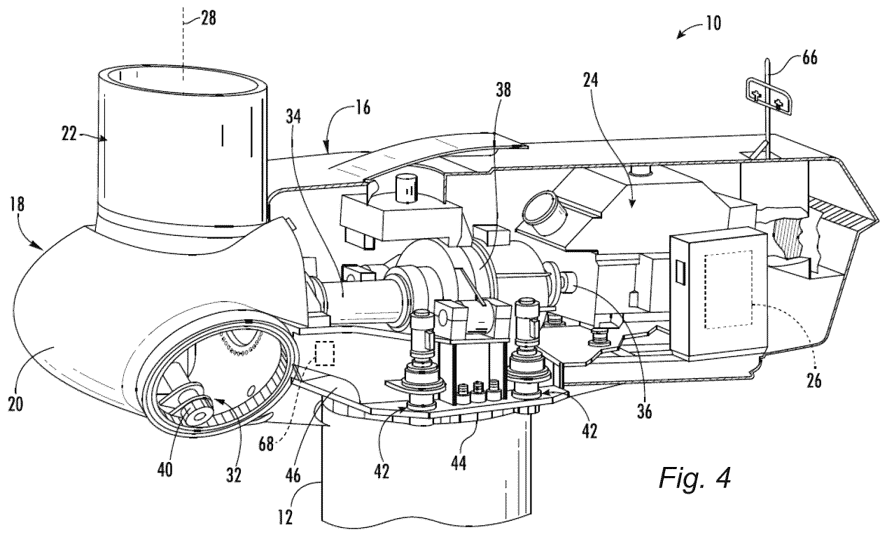

Referring to the drawings, FIG. 3 illustrates a perspective view of one embodiment of a wind turbine 10 according to the present disclosure. The wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 4) positioned within the nacelle 16 to permit electrical energy to be produced.

The wind turbine 10 may also include a wind turbine controller 26 centralized within the nacelle 16. However, in other embodiments, the controller 26 may be located within any other component of the wind turbine 10 or at a location outside the wind turbine 10. Further, the controller 26 may be communicatively coupled to any number of the components of the wind turbine 10 in order to control the operation of such components and/or implement a corrective or control action. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals. Accordingly, the controller 26 may generally be configured to control the various operating modes (e.g., start-up or shut-down sequences), de-rating or up-rating the wind turbine, and/or individual components of the wind turbine 10.

Referring now to FIG. 4, a simplified, internal view of one embodiment of the nacelle 16 of the wind turbine 10 shown in FIG. 3 is illustrated. As shown, a generator 24 may be disposed within the nacelle 16 and supported atop a bedplate 46. In general, the generator 24 may be coupled to the rotor 18 for producing electrical power from the rotational energy generated by the rotor 18. For example, as shown in the illustrated embodiment, the rotor 18 may include a rotor shaft 34 coupled to the hub 20 for rotation therewith. The rotor shaft 34 may, in turn, be rotatably coupled to a generator shaft 36 of the generator 24 through a gearbox 38. As is generally understood, the rotor shaft 34 may provide a low speed, high torque input to the gearbox 38 in response to rotation of the rotor blades 22 and the hub 20. The gearbox 38 may then be configured to convert the low speed, high torque input to a high speed, low torque output to drive the generator shaft 36 and, thus, the generator 24.

The wind turbine 10 may also one or more pitch drive mechanisms 32 communicatively coupled to the wind turbine controller 26, with each pitch adjustment mechanism(s) 32 being configured to rotate a pitch bearing 40 and thus the individual rotor blade(s) 22 about its respective pitch axis 28. In addition, as shown, the wind turbine 10 may include one or more yaw drive mechanisms 42 configured to change the angle of the nacelle 16 relative to the wind (e.g., by engaging a yaw bearing 44 of the wind turbine 10 that is arranged between the nacelle 16 and the tower 12 of the wind turbine 10).

In addition, the wind turbine 10 may also include one or more sensors 66, 68 for monitoring various wind conditions of the wind turbine 10. For example, the incoming wind direction 52, wind speed, or any other suitable wind condition near of the wind turbine 10 may be measured, such as through use of a suitable weather sensor 66. Suitable weather sensors may include, for example, Light Detection and Ranging (“LIDAR”) devices, Sonic Detection and Ranging (“SODAR”) devices, anemometers, wind vanes, barometers, radar devices (such as Doppler radar devices) or any other sensing device which can provide wind directional information now known or later developed in the art. Still further sensors 68 may be utilized to measure additional operating parameters of the wind turbine 10, such as voltage, current, vibration, etc. as described herein.

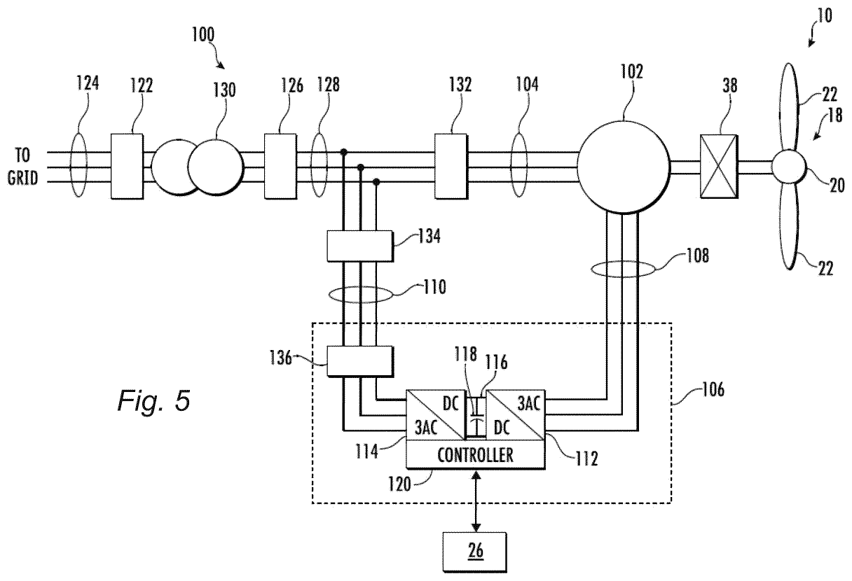

Referring now to FIG. 5, a schematic diagram of one embodiment of a wind turbine power system 100 is illustrated in accordance with aspects of the present disclosure. Although the present disclosure will generally be described herein with reference to the wind turbine 10 shown in FIGS. 3 and 4, those of ordinary skill in the art, using the disclosures provided herein, should understand that aspects of the present disclosure may also be applicable in other power generation systems, and, as mentioned above, that the invention is not limited to wind turbine systems.

In the embodiment of FIG. 5, the rotor 18 of the wind turbine 10 may, optionally, be coupled to the gearbox 38, which is, in turn, coupled to a generator 102, which may be a doubly fed induction generator (DFIG). As shown, the DFIG 102 is connected to a stator bus 104. Further, as shown, a power converter 106 is connected to the DFIG 102 via a rotor bus 108, and to the stator bus 104 via a line side bus 110. As such, the stator bus 104 provides an output multiphase power (e.g., three-phase power) from a stator of the DFIG 102, and the rotor bus 108 provides an output multiphase power (e.g., three-phase power) from a rotor of the DFIG 102. The power converter 106 includes a rotor-side converter (RSC) 112 and a line-side converter (LSC) 114. The DFIG 102 is coupled via the rotor bus 108 to the rotor-side converter 112. Additionally, the RSC 112 is coupled to the LSC 114 via a DC link 116 across which is a DC link capacitor 118. The LSC 114 is, in turn, coupled to the line side bus 110.

The RSC 112 and the LSC 114 are configured for normal operating mode in a three-phase, pulse width modulation (PWM) arrangement using one or more switching devices, such as insulated gate bipolar transistor (IGBT) switching elements. In addition, the power converter 106 may be coupled to a converter controller 120 in order to control the operation of the rotor-side converter 112 and/or the line-side converter 114, as described herein. It should be noted that the converter controller 120 may be configured as an interface between the power converter 106 and the turbine controller 26 and may include any number of control devices.

In typical configurations, various line contactors and circuit breakers including, for example, a grid breaker 122 are included for isolating the various components as necessary for normal operation of the DFIG 102 during connection to and disconnection from a load, such as the electrical grid 124. For example, a system circuit breaker 126 may couple a system bus 128 to a transformer 130, which may be coupled to the electrical grid 124 via the grid breaker 122. In alternative embodiments, fuses may replace some or all of the circuit breakers.

In operation, alternating current power generated at the DFIG 102 by rotating the rotor 18 is provided to the electrical grid 124 via dual paths defined by the stator bus 104 and the rotor bus 108. On the rotor bus 108, sinusoidal multi-phase (e.g., three-phase) alternating current (AC) power is provided to the power converter 106. The rotor-side converter 112 converts the AC power provided from the rotor bus 108 into direct current (DC) power and provides the DC power to the DC link 116. As is generally understood, switching elements (e.g., IGBTs) used in the bridge circuits of the rotor-side converter 112 are modulated to convert the AC power provided from the rotor bus 108 into DC power suitable for the DC link 116.

In addition, the line-side converter 114 converts the DC power on the DC link 116 into AC output power suitable for the electrical grid 124. In particular, switching elements (e.g., IGBTs) used in bridge circuits of the line-side converter 114 are modulated to convert the DC power on the DC link 116 into AC power on the line side bus 110. The AC power from the power converter 106 can be combined the power from the stator of DFIG 102 to provide multi-phase power (e.g., three-phase power) having a frequency maintained substantially at the frequency of the electrical grid 124 (e.g., 50 Hz or 60 Hz).

Additionally, various circuit breakers and switches, such as grid breaker 122, system breaker 126, stator sync switch 132, converter breaker 134, and line contactor 136 may be included in the wind turbine power system 100 to connect or disconnect corresponding buses, for example, when current flow is excessive and may damage components of the wind turbine power system 100 or for other operational considerations. Additional protection components may also be included in the wind turbine power system 100.

Moreover, the power converter 106 may receive control signals from, for instance, an upstream control system (e.g., the turbine controller or a wind farm controller) via the converter controller 120. The control signals may be based, among other things, on sensed states or operating characteristics of the wind turbine power system 100. Typically, the control signals provide for control of the operation of the power converter 106. For example, feedback in the form of a sensed speed of the DFIG 102 may be used to control the conversion of the output power from the rotor bus 108 to maintain a proper and balanced multi-phase (e.g., three-phase) power supply. Other feedback from other sensors may also be used by the controller(s) 120, 26 to control the power converter 106, including, for example, stator and rotor bus voltages and current feedbacks. Using the various forms of feedback information, switching control signals (e.g., gate timing commands for IGBTs), stator synchronizing control signals, and circuit breaker signals may be generated.

The power converter 106 also compensates or adjusts the frequency of the three-phase power from the rotor for changes, for example, in the wind speed at the hub 20 and the rotor blades 22. Therefore, mechanical and electrical rotor frequencies are decoupled, and the electrical stator and rotor frequency matching is facilitated substantially independently of the mechanical rotor speed.

Under some states, the bi-directional characteristics of the power converter 106, and specifically, the bi-directional characteristics of the LSC 114 and RSC 112, facilitate feeding back at least some of the generated electrical power into the generator rotor. More specifically, electrical power may be transmitted from the stator bus 104 to the line side bus 110 and subsequently through the line contactor 136 and into the power converter 106, specifically the LSC 114 which acts as a rectifier and rectifies the sinusoidal, three-phase AC power to DC power. The DC power is transmitted into the DC link 116. The capacitor 118 facilitates mitigating DC link voltage amplitude variations by facilitating mitigation of a DC ripple sometimes associated with three-phase AC rectification.

The DC power is subsequently transmitted to the RSC 112 that converts the DC electrical power to a three-phase, sinusoidal AC electrical power by adjusting voltages, currents, and frequencies. This conversion is monitored and controlled via the converter controller 120. The converted AC power is transmitted from the RSC 112 via the rotor bus 108 to the generator rotor. In this manner, generator reactive power control is facilitated by controlling rotor current and voltage.

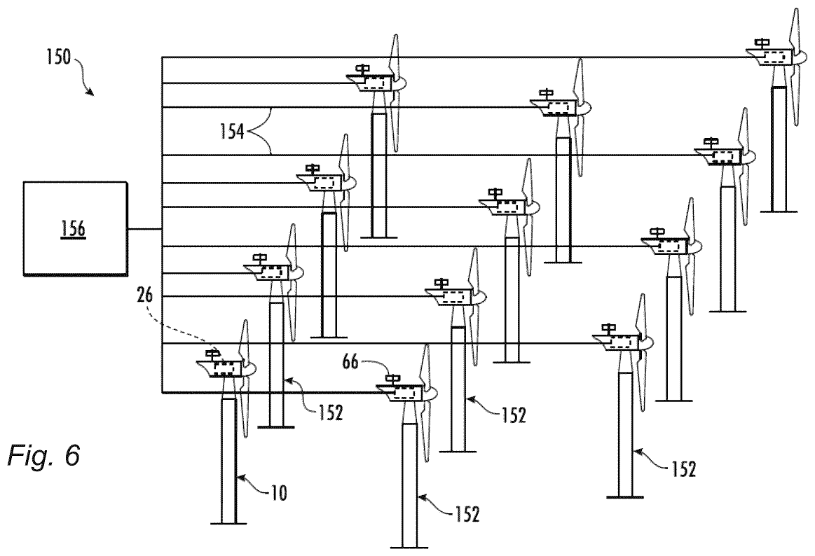

Referring to FIG. 6, the wind turbine power system 100 described herein may be part of a wind farm 150. As shown, the wind farm 150 may include a plurality of wind turbines 152, including the wind turbine 10 described above, and an overall farm-level controller 156. The individual turbine controllers of the respective plurality of wind turbines 152 are communicatively coupled to the farm-level controller 156, e.g., through a wired connection, such as by connecting the turbine controller 26 through suitable communicative links 154 (e.g., a suitable cable). Alternatively, the turbine controllers 26 may be communicatively coupled to the farm-level controller 156 through a wireless connection, such as by using any suitable wireless communications protocol known in the art. In further embodiments, the farm-level controller 156 is configured to send and receive control signals to and from the various wind turbines 152, such as for example, distributing real and/or reactive power demands across the wind turbines 152 of the wind farm 150.

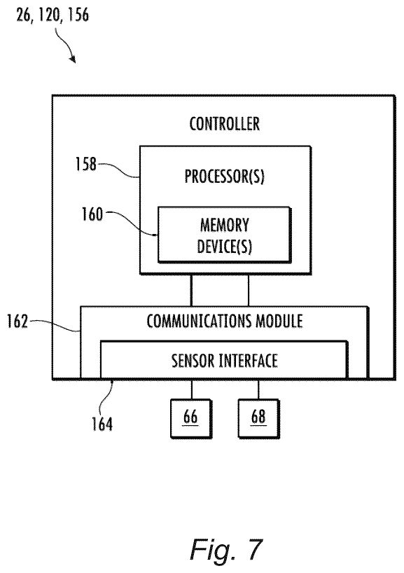

Referring now to FIG. 7, a block diagram of one embodiment of suitable components that may be included within the controller (such as any one of the converter controller 120, the turbine controller 26, and/or the farm-level controller 156 described herein) is illustrated. The controller may include one or more processor(s) 158, computer, or other suitable processing unit and associated memory device(s) 160 that may include suitable computer-readable instructions that, when implemented, configure the controller to perform various different functions, such as receiving, transmitting and/or executing wind turbine control signals (e.g., performing the methods, steps, calculations, and the like disclosed herein).

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 60 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements.

Such memory device(s) 160 may generally be configured to store suitable computer-readable instructions that, when implemented by the processor(s) 158, configure the controller to perform various functions as described herein. Additionally, the controller may also include a communications interface 162 to facilitate communications between the controller and the various components of the wind turbine 10. An interface can include one or more circuits, terminals, pins, contacts, conductors, or other components for sending and receiving control signals. Moreover, the controller may include a sensor interface 164 (e.g., one or more analog-to-digital converters) to permit signals transmitted from the sensors 66, 68 to be converted into signals that can be understood and processed by the processor(s) 158.

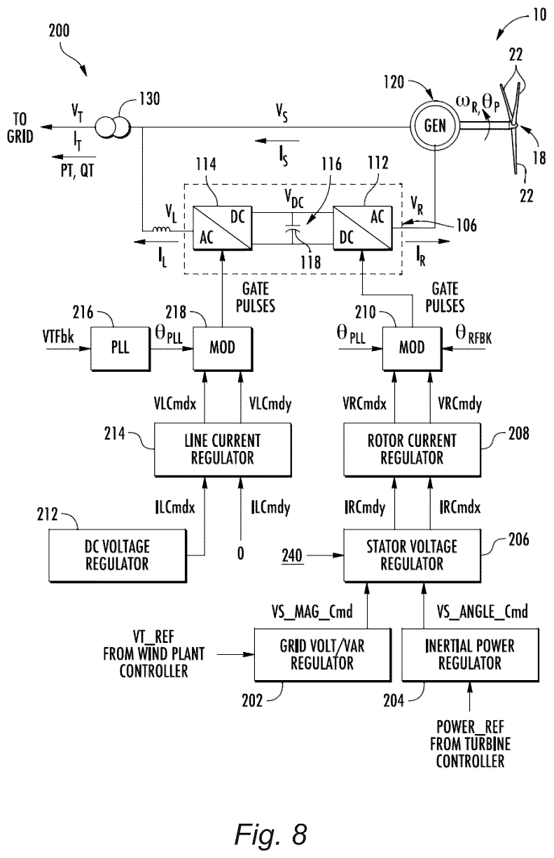

Referring now to FIG. 8, a system 200 for providing grid-forming control of a double-fed generator of a wind turbine is illustrated. In particular, FIG. 8 illustrates a schematic diagram of one embodiment of the system 200 according to the present disclosure, particularly illustrating a one-line diagram of the double-fed wind turbine generator 102 with a high-level control structure for grid-forming characteristics.

As shown, the system 200 may include many of the same features of FIG. 5 described herein, with components having the same reference characters representing like components. As shown, the line-side converter 114 control structure may include a DC regulator 212 and a line current regulator 214. The DC regulator 212 is configured to generate line-side current commands for the line current regulator 214. The line current regulator 214 then generates line-side voltage commands for a modulator 218. The modulator 218 also receives an output (e.g., a phase-locked loop angle) from a phase-locked loop 216 to generate one or more gate pulses for the line-side converter 114. The phase-locked loop 216 typically generates its output using a voltage feedback signal.

Furthermore, as shown, the system 200 includes a control structure for controlling the rotor-side converter 112 using grid-forming characteristics. In particular, the system 200 may include a stator voltage regulator 206 for providing such grid-forming characteristics. In addition, as shown, the system 200 may include a grid voltage/VAR regulator 202, an inertial power regulator 204, a rotor current regulator 208, and a modulator 210.

More particularly, the system 200 includes an inner-loop current-regulator structure and a fast stator voltage regulator to convert voltage commands from the grid-forming controls to rotor current regulator commands. Thus, the system provides control of the rotor voltage of the double-fed wind turbine generator 102 to meet a higher-level command for magnitude and angle of stator voltage. Such control is relatively fast and insensitive to current flowing in the stator of the double-fed wind turbine generator 102.

Furthermore, the inertial power regulator 204 of this system 200 implements various functions, including (1) following the active power reference supplied by the turbine control, and (2) sharing power among other parallel connected resources. Following the active power reference supplied by the turbine control is practically achieved through modification of the angle command to the stator voltage control, whereas sharing the power among other parallel connected resources is practically achieved through a frequency droop.

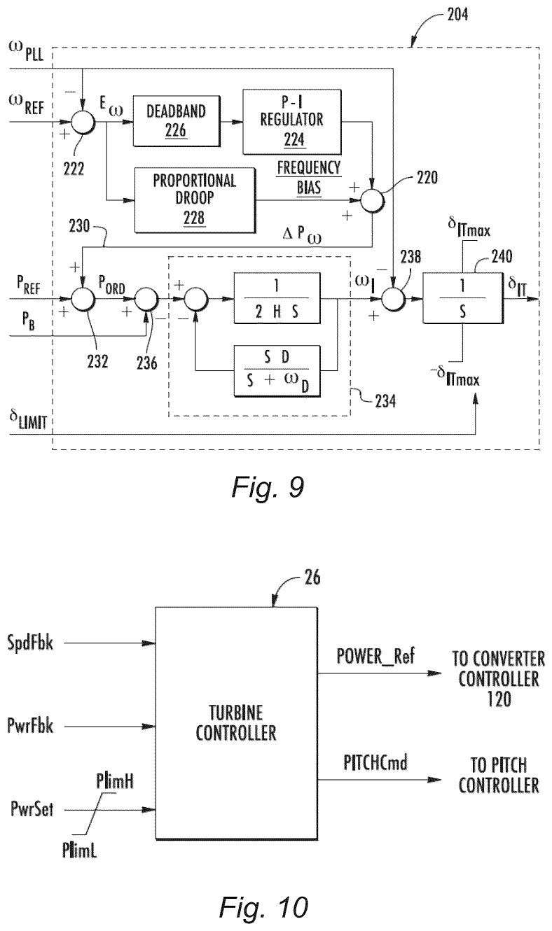

Referring now to FIG. 9, an expanded block diagram of the inertial power regulator 204 with frequency droop is provided. As shown, the frequency reference signal ω_{REF} and the phase lock loop frequency signal ω_{PLL} are constrained to generate the frequency error signal E_{ω}. Specifically, the ω_{PLL} signal, which represents the actual frequency of the inverter output is subtracted from the ω_{REF} signal in a summing junction 222 to generate the E_{ω} error signal. The E_{ω} error signal is provided to a frequency control having a first control loop including a conventional proportional plus integral regulator 224 and a deadband control 226. The deadband circuit 226 provides some range of variation of the frequency error signal, for example, approximately ½ Hz without any change of output signal. This limits response due to natural fluctuations of the power system frequency. The proportional plus integral regulator 224 converts the error signal to a conventional bias signal which is applied to a summing junction 220.

A second loop includes a proportional droop circuit 228 which may be an amplifier with a fixed gain that receives the E_{ω} error signal and provides an immediate compensation signal to the summing junction 220, the compensation signal being added to the output signal from the proportional plus integral regulator 224. The output of the summing junction 230 is a power offset signal which is coupled to a summing junction 232 whose other input is the power reference signal P_{REF}. Accordingly, the frequency offset signal from summing junction 220 serves to modify the power reference signal P_{REF}. The purpose of such modification is to adjust the power reference signal P_{REF} as a function of frequency shifts. More particularly, the intent of the system is to attempt to hold the system output frequency constant so that if there is an error between the output frequency and the reference frequency, the power reference signal P_{REF} is adjusted to compensate for the frequency error.

Thus, as shown, the proportional droop circuit 228 modifies the power reference P_{REF} from the turbine control by adding a droop term (i.e., the output 230 from 220) determined by the difference between the frequency reference and the actual frequency. Under normal conditions, the grid frequency is close to nominal and the droop term is zero. When there is an imbalance in generation and load, the grid frequency may deviate from nominal and the droop term will cause the power converter 106 to generate power different from the power reference P_{REF} from the turbine control. The impact of this power deviation on the turbine control may be unintended changes in speed of the drivetrain, potentially leading to trips of the wind turbine 10.

Still referring to FIG. 9, the inertial power regulator 204 also introduces an inertial regulator 234 which modifies the power error signal to simulate the inertia of synchronous machines. More particularly, the inertial regulator 204 prevents sudden frequency changes or power changes which can cause transient torques to be generated by the motors coupled to the inverter output if sudden changes in the inverter output are experienced. The inertial regulator 234 may include a conventional electronic circuit having the characteristics of a filtered differential element in that its output signal gradually increases in response to an increase in the input signal.

If the power reference signal is modified by the frequency bias circuit, the resultant signal identified as P_{ORD} is developed at an output terminal of the summing junction 232 and applied to a summation circuit 236 where the commanded power or ordered power is compared to the measured output power P_{B} of the system. Note here that the signal P_{B} represents the real power developed at the output of the inverter. The output signal from the summation circuit 236 represents the power error signal which is applied to the inertial regulator 234. The signal developed by the inertial regulator as described above represents the desired frequency ω₁ of the internal voltage E₁ and, if the frequency is properly tracking, will be the same as the frequency ω_{PLL}. In this regard, the signal ω₁ developed at the output of the inertial regulator 234 is summed in a summing junction 238 with the ω_{PLL} signal. Any difference between the phase lock loop frequency and the signal ω₁ results in an error signal which is applied to a filtered differential element 240 to develop the δ_{IT} signal. In such embodiments, the filtered differential element 240 may be a conventional type of filtered differential element whose output signal δ_{IT} is an angle offset which can be summed with the output signal from the phase lock loop to generate the output signal θ₁.

Referring now to FIG. 10, a simplified, block diagram of the main inputs and outputs of the turbine controller 26 is provided. The primary objective of the turbine controller 26 is to maximize power generated by the generator 102 based on available power from the wind and within the power constraint imposed by the power setpoint limit PwrSet. Typically, the turbine controller 26 achieves this objective by regulating the speed and active power of the generator 102. Thus, the turbine controller 26 utilizes maximum power-point tracking algorithms to determine a power reference to the converter controller 120 and a pitch command to the pitch control to realize these control objectives.

Under normal grid conditions, the power setpoint (PwrSet) is set to nominal power rating of the generator 102. The turbine controller 26 adjusts pitch and converter power references to maximize the power output within the power setpoint. Therefore, actual power may deviate significantly from the setpoint based on wind conditions, but generally stays below the power setpoint. Under curtailed conditions, the power setpoint is reduced below nominal power rating, but the controls continue to operate the same way but are constrained to a lower power. Note that the power setpoint may also be interpreted as a power limit, as the controller is allowed to produce as much power as possible within this constraint.

As explained above, an inherent characteristic of GFM IBRs (such as the wind turbine generators discussed above) is that they inherently support grid frequency and angle stability in a similar way as synchronous machines. A GFM IBR automatically changes power output to stabilize the grid with negligible time delays and without deadbands. The upstream (higher-level) power regulating control functions, such as the wind turbine controller and farm-level controllers discussed above, tend to counteract this inherent response. An aim of the present methodology is to minimize this disadvantageous countereffect.

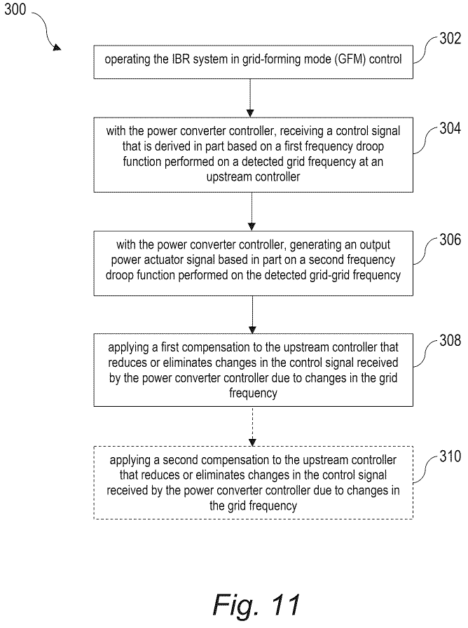

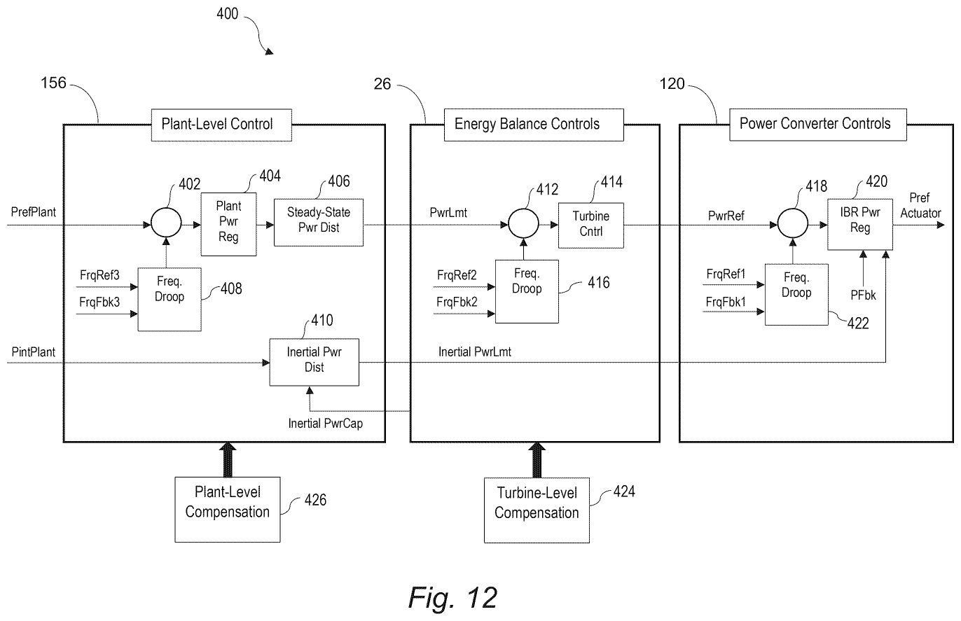

FIG. 11 depicts a flow chart of a method embodiment 300 in accordance with the invention for achieving the stated objective. FIGS. 12-14 are diagrams of system 400 embodiments for practicing the method.

Referring to FIGS. 11-14, the method 300 and system 400 are related to operating an IBR system in grid-forming mode (GFM) control. For purposes of explanation, the IBR is presented as a wind turbine power system having at least one power converter coupled to a generator, wherein the power converter controller receives control signal(s) from an upstream controller, such as a wind turbine controller and/or a wind farm controller. However, it should be appreciated that the disclosed method 300 may be implemented with any other suitable power generation systems having any other suitable configurations. In addition, one skilled in the art, using the disclosures provided herein, will appreciate that various steps of the methods disclosed herein can be omitted, rearranged, constrained, and/or adapted in various ways without deviating from the scope of the present disclosure.

Referring to FIG. 12, the power converter controller 120 (coupled to the power converter 106 in FIG. 5) is depicted and is configured as an interface between the power converter and the turbine controller 26. Within the controller 120, a power reference signal (PwrRef) is received from the wind turbine controller 26. At 422, a frequency droop function is performed based on the reference frequency signal (FrqRef1) and the frequency feedback signal (FrqFbk1) corresponding to the detected grid frequency and modifies the power reference signal at the junction 418. The frequency droop function adjusts the power reference signal to support the grid frequency, like conventional droop control functions in other types of generators. The IBR power regulator 420 receives the modified power reference signal, as well as a power feedback signal (PFbk) and generates the reference power actuator signal (δ) that is usually a power angle signal used to adjust the angle of the grid-forming voltage source created by the IBR. This power angle may be used to generate the bridge gate pulses of the power converter directly or used to synthesize a voltage source through a stator voltage regulator (as in a dual-fed type generator system) (FIG. 5). The power regulator 420 may also receive an inertial power limit signal (Inertial PwrLmt) from an upstream controller, such as the plant level controller 156, as discussed in greater detail below. This power regulator 420 may also be an inertial power regulator similar to the form shown in FIG. 9.

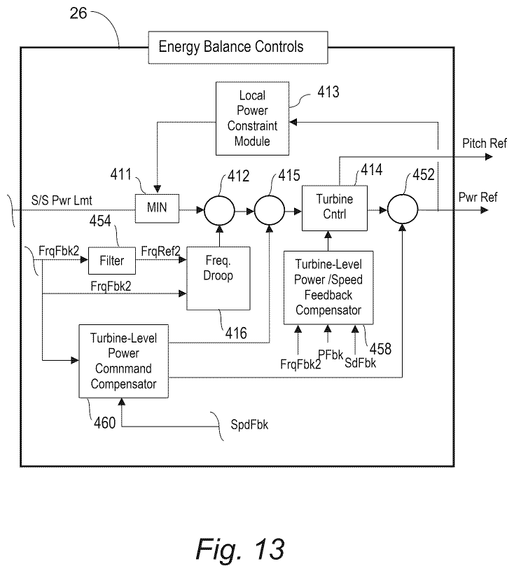

Still referring to FIG. 12, the wind turbine controller 26 is schematically illustrated. A first power limit signal (PwrLmt) may be received from an upstream controller, such as the plant-level controller 156. As shown in FIG. 13, the turbine controller 26 may include a local power constraint module 413 that generates a second power limit signal for the turbine controller 26. A minimum module 411 may be configured to determine a constrained power limit signal as a function of the first and second power limit signals.

A frequency droop function is performed between a reference frequency signal (FrqRef2) and the frequency feedback signal (FrqFbk2) corresponding to the detected grid frequency and is used to modify the power limit signal (PwrLmt) at the junction 412. The turbine control circuitry 414 receives the modified power limit signal and generates the power reference signal (PwrRef) transmitted to the power converter controller 120 (discussed above). Thus, the wind turbine controller 26 is considered as an “upstream controller” to the power converter controller 120.

FIG. 12 also schematically depicts a plant-level controller 156 that is upstream to the wind turbine controller 26 and to the power converter controller 120. This controller 156 receives a plant power reference signal (PrefPlant) for the entire plant (wind farm). A frequency droop function is performed between a reference frequency signal (FrqRef3) and the frequency feedback signal (FrqFbk3) corresponding to the detected grid frequency and is used to modify the plant power reference signal (PrefPlant) at the junction 402. The modified plant power reference signal is received by a plant power regulator 404, which generates a total power requirement signal for the plant. At 406, a steady state power distribution of the total power signal is made for the individual wind turbines, wherein the power limit signal (PwrLmt) discussed above is generated and transmitted to the wind turbine controller 26.

The plant-level controller 156 may include an inertial power distribution function 410 that receives a plant inertial power signal and an inertial power cap signal (Inertial PwrCap) signal from the individual wind turbine controllers 26, wherein an inertial power limit signal (Inertial PwrLmt) is generated and transmitted to the individual power converter regulators 120 (for all of the wind turbines within the wind farm).

Referring to FIG. 12, as discussed above, each of the converter controls 120, wind turbine controls 26, and plant-level controls 156 contain frequency droop functions. The frequency droop functions downstream of the plant-level control 156 are essentially washed out over time to allow the plant-level control 156 to dictate plant droop response in steady-state. However, as discussed above, the GFM IBR controller 120 inherently supports grid frequency and angle stability in a similar way as synchronous machines. The GFM IBR automatically changes power output to stabilize the grid with negligible time delays and without deadbands. A side effect of the upstream power regulating functions (e.g., the wind turbine controller 26 and plant-level controller 156) is that they counteract this inherent response of the GFM IBR.

The method 300 and system 400 serve to minimize or eliminate this counter effect of the upstream controllers 120, 26 by the addition of compensation components 424, 426 within the wind turbine controls 26 and/or the plant-level controls 156, as depicted in FIG. 12.

Referring to FIGS. 11-12, at step 302 in FIG. 11, the method includes operating the IBR system in GFM control mode, as explained above. The IBR system may be a wind turbine generator, wherein the upstream controller is a wind turbine controller, and the control signal received by the power converter controller is a power reference signal generated by the wind turbine controller.

At step 304, the power converter controller 120 receives a control signal that is derived at least in part based on a first frequency droop function performed on a detected grid frequency at an upstream controller. For example, referring to FIG. 12, the IBR power converter controller 120 receives the power reference signal (PwrRef) from the upstream wind turbine controller 26, which was derived in part based on the frequency droop function 416 performed in the wind turbine controller.

At step 306, the power converter controller generates an output power actuator signal based in part on a frequency droop function performed on the detected grid-grid frequency in the power converter controller. For example, the power converter controller 120 generates the reference power actuator signal (Pref) based on the modified power reference signal and the power feedback signal (PFbk).

At step 308, a first compensation (e.g., the turbine-level compensation 424 or the plant-level compensation 426) is generated and applied to the upstream controller (e.g., one of the wind turbine controller 26 or the plant-level controller 156) that reduces or eliminates changes in the control signal received by the power converter controller 120 due to changes in the detected grid frequency.

At step 310, the method 300 may include applying a second compensation (e.g., the other of the turbine-level compensation 424 or the plant-level compensation 426) to an additional upstream controller (e.g., the other of the wind turbine controller 26 or the plant-level controller 156) that further reduces or eliminates changes in the control signal received by the power converter controller due to changes in the grid frequency.

In a particular embodiment of the method 300, the first compensation functionality may be the turbine-level compensation functionality depicted in FIG. 13. Referring to FIG. 13, the frequency droop function 416 is performed based on the frequency reference signal (FrqRef2) and the frequency feedback signal (FrqFbk2), as discussed above. In this embodiment, the frequency reference signal (FrqRef2) may be based on a filtered version of the grid frequency feedback. Additionally, the frequency reference signal (FrqRef1) supplied to the power converter controls 120 (FIG. 12) may also be based on a filtered version of the grid frequency feedback, wherein a filter bandwidth of the first frequency droop function 416 may be lower than a filter bandwidth of the second frequency droop function 418. The first frequency droop function 416 is applied to the power limit signal 406 and generally includes one or more parameter settings defining the amount of power change from a deviation in grid frequency.

Still referring to FIG. 13, the turbine-level compensation functionality 424 (FIG. 12) may be provided by a turbine-level power command compensation 460 based on an anticipated response of the downstream power converter controls 120 together with the wind turbine controller 26 response itself so that the total wind turbine generator response to grid frequency follows a target overall system response for the wind turbine generator. The power command compensation 460 may use the grid frequency feedback signal (FrqFbk2) and a generator rotor speed feedback signal (SpdFbk) to generate a power change signal that may be used at the input (at junction 415) and/or the output (at junction 452) of the corresponding turbine controller 414 to minimize or eliminate the change in the power reference output signal (PwrRef) from changes in grid frequency (thus fully allowing the downstream power converter controls 120 to manage the grid-support functions alone without interference from the energy balance functionality of the wind turbine controls 126). Therefore, the design of the power command compensation may also need to consider the control structure and design settings of the energy balance controller. Under normal or unchanging grid-frequency conditions, the power change signal would be zero and the power regulation and energy balance functions as normal.

In another embodiment, again referring to FIG. 13, the turbine-level compensation functionality 424 (FIG. 12) may be provided by a turbine-level power or speed feedback compensation 458 that receives a wind turbine power feedback signal (PFbk) or a wind turbine speed feedback signal (SpFbk) and the detected grid frequency feedback signal (FrqFbk2). This compensation function is intended to provide a power or speed feedback signal to the turbine controls 414 to reduce or eliminate changes in active power feedback associated with grid-frequency/phase angle changes. By removing these specific changes in power from the feedback power, the wind turbine controller 26 may avoid counteracting the response of the downstream power converter controls 120. This component 458 may function by emulating the power regulator equations of the power converter regulator 420 (FIG. 12) with assumptions on grid impedance to estimate the changes in power due only to changes in grid frequency/phase (for example, as done in conventional generator swing equation). In this way, the compensated power feedback would normally match the actual power feedback under normal or unchanging grid frequency conditions, and the power regulators and energy balance controls would operate as normal. However, under changing grid frequency conditions, the compensated power feedback will temporarily show little or no change in active power so that the controller has little or no response to the frequency/phase angle event.

In a particular embodiment, the turbine-level compensation functionality 424 (FIG. 12) may be provided by a combination of the turbine-level power command compensation 460 and the turbine-level power feedback compensation 458 discussed above.

Referring to FIG. 12, in another embodiment wherein the IBR is a wind turbine generator, and the control signal is a power reference signal generated by the wind turbine controller 26, the plant level controller 156 may be considered as the upstream controller, wherein this upstream controller generates the power limit signal received and used by the wind turbine controller 26 to generate the power reference signal (the control signal) used by the power converter regulator 120. Thus, in this embodiment, the control signal is derived in part based on the frequency droop function performed on the detected grid frequency at the plant-level controller (the upstream controller. In this embodiment, the first compensation function may be provided by the plant-level compensation functionality 426 at the plant-level controller 156.

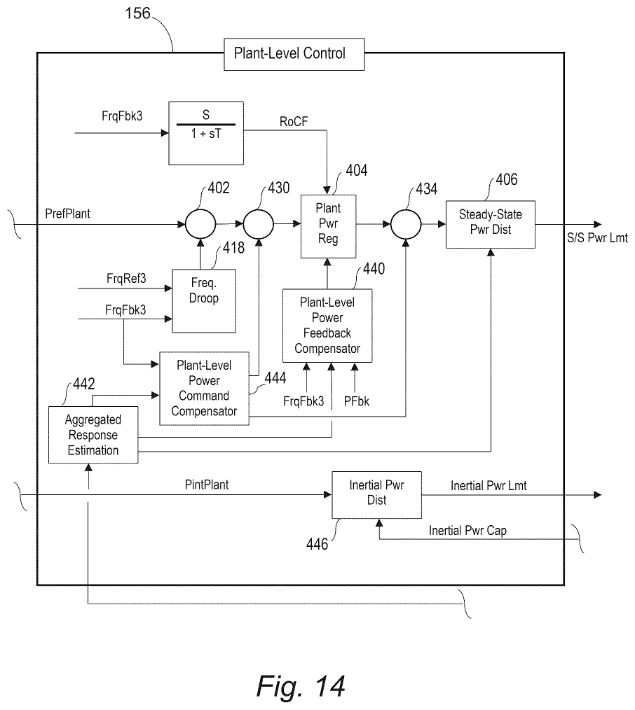

Referring to FIG. 14, the plant-level compensation may be provided by a plant-level power command compensation 444. The input to this compensation 444 is the detected frequency feedback signal (FrqFbk3) and the output is a power change signal that may be used at the input (at junction 430) and/or the output (at junction 434) of the corresponding plant power regulator 404. The power change signal is zero under constant frequency conditions. The power compensation function is based on an anticipated response of the downstream controls together with the power regulator response itself so that the complete system response to frequency follows a target overall system response. The configuration of the plant-level power command compensation 444 may be adjusted based on input from an aggregated response estimation 442 that predicts a collective response in active power of a group of the wind turbine generators in a plant to grid frequency changes. The input to the aggregated response estimation function 442 may include one or more feedbacks from the individual IBR units, and may include status signal (online or offline), Virtual inertia setting/capability, where the turbine is operating as a GFM or GFL resource, or other operating point information (speeds/power, etc.)

The structure for the plant-level power command compensation may include multiple parallel paths, such as one path for small-signal changes in frequency with relatively small limits on the power changes and another path for large changes in phase and/or frequency (which may include a frequency deadband and/or rate limit). If multiple paths are used, the outputs are summed together to get a total power change signal. A practical implementation may include one or multiple washout filters with dynamic gain, filter time constant, and limits that are dynamically scaled based possible power and wind turbine generator status.

Still referring to FIG. 14, in another embodiment, the first compensation may be provided by a plant-level power feedback compensation 440 based on a plant power feedback signal (PFbk) and the detected grid frequency (FrqFbk3). Similar to the power feedback compensation in the wind turbine controller, this function is intended to provide a power feedback signal to the plant power regulator to reduce or eliminate power changes associated with grid-frequency/phase angle changes. By removing these specific changes in power from the feedback power, the plant-level controls 156 may avoid counteracting the response of the downstream power converter controls 120. This component 440 may function by emulating the power regulator equations of the power converter regulator 420 (FIG. 12) with assumptions on grid impedance to estimate the changes in power due only to changes in grid frequency/phase. For example, the plant-level power feedback compensation could include a model the collection of inverter-based resources as a single lumped generator using conventional generator swing equation. With grid frequency feedback as an input and an assumption on equivalent reactance, the change in power due to grid frequency could be estimated and used to compensate the actual power feedback. Similarly, the gains of the swing equation could be adjusted based on feedbacks of the status, operating points, and capabilities of the collection of IBR being controlled by the plant-level regulator.

The configuration of the plant-level power feedback compensation 440 may be adjusted based on input from the aggregated response estimation 442 that predicts a collective response in active power of a group of the wind turbine generators in a plant to grid frequency changes.

Still referring to FIG. 14, in another embodiment, the first compensation may be provided by a signal (RoCoF) derived from rate-of-change of the detected grid frequency applied to the plant power regulator 404. This function may serve to freeze the plant power regulator 404 based on the rate-of-change of the grid frequency. Due to communication delays from the plant-level controls 156 to the wind turbine generators, it may be desired to freeze the response of the plant power regulator 404 to severe frequency events due to the very fast response of the wind turbine generators. The regulator 404 may be unfrozen when the RoCoF signal is zero over a pre-defined period of time to resume plant-level power regulation.

Yet another embodiment includes providing the first compensation based on any combination of: (a) the plant-level power command compensation 444; (b) the plant-level power feedback compensation 440; or (c) the signal derived from rate-of-change of detected grid frequency applied to the plant power regulator 404.

The present invention also encompasses various system and method embodiments for operating a wind turbine generator in a wind turbine plant having a plurality of wind turbines connected to a power grid, wherein the wind turbines include a wind turbine controller 26 in communication with a plant-level controller 156. The wind turbine generators include a power converter controller 120, all of which are discussed above.

The wind turbine generator is operated in grid-forming mode (GFM) control, and the power converter controller 120, receives a first control signal derived by the wind turbine controller 26 based on a frequency droop function performed on a detected grid frequency by the wind turbine controller. The wind turbine controller 26 receives a second control signal derived by the plant-level controller 156 based on a frequency droop function performed on the detected grid frequency by the plant-level controller 156. The power converter controller 120 generates an output power actuator signal based in part on a frequency droop function performed on the detected grid frequency by the power converter controller.

A first compensation is provided to the wind turbine controller 26 and may include any one or combination of the turbine-level compensations discussed above. A second compensation is provided to the plant-level controller 156 and may include any one or combination or the plant-level compensations discussed above. The first and second compensations reduce or eliminate changes in the control signal received by the power converter controller due to changes in the grid frequency, as discussed in detail above.

The present invention also encompasses an individual wind turbine having a wind turbine generator configured as an inverter-based resource (IBR) renewable energy source connected to a power grid and controlled by a power converter controller. The wind turbine generator is configured for operation in accordance with any one or combination of the methods discussed above.

Likewise, the present disclosure encompasses a wind turbine plant having a plurality of the wind turbines.

Further aspects of the invention are provided by the subject matter of the following clauses:

Clause 1: A method for operating a renewable energy source having an inverter-based resource (IBR) system (which may be connected to a power grid or in and islanded system) and controlled by a power converter controller, the method comprising: operating the IBR system in grid-forming mode (GFM) control; with the power converter controller, receiving a control signal that is derived based on one of an inertial power regulator or a frequency droop function performed on a detected grid frequency at an upstream controller; with the power converter controller, generating an output power actuator signal based on a frequency droop function performed on the detected grid frequency at the power converter controller; and applying a first compensation to the upstream controller that reduces or eliminates changes in the control signal received by the power converter controller due to changes in the grid frequency or phase angle.

Clause 2: The method according to clause 1, wherein the IBR is a wind turbine generator, the upstream controller is a wind turbine controller, and the control signal received by the power converter controller is a power reference signal generated by the wind turbine controller.

Clause 3: The method according to clause 1 or 2, wherein the first compensation is provided by a turbine-level power command compensation based on the detected grid frequency.

Clause 4: The method according to any one of clauses 1-3, wherein the first compensation provided by the turbine-level power command compensation is also based on a generator rotor speed feedback signal.

Clause 5: The method according to any one of clauses 1-4, wherein the first compensation is provided by a turbine-level power or speed feedback compensation based on a wind turbine power or speed feedback signal and the detected grid frequency.

Clause 6: The method according to any one of clauses 1-5, wherein the first compensation is provided by a turbine-level power command compensation based on the detected grid frequency and a turbine-level power feedback compensation based on a wind turbine power feedback signal and the detected grid frequency.

Clause 7: The method according to any one of clauses 1-6, wherein the IBR is a wind turbine generator, and the control signal is a power reference signal generated by the wind turbine controller, wherein the upstream controller is a plant level controller that generates a power limit signal received by the wind turbine controller, the power limit signal used by the wind turbine controller to generate the power reference signal.

Clause 8: The method according to any one of clauses 1-7, wherein the first compensation is provided by a plant-level power command compensation based on the detected grid frequency.

Clause 9: The method according to any one of clauses 1-8, wherein the plant-level power command compensation is also based on an aggregated response estimation signal that predicts a collective response in active power of a group of the wind turbine generators in a plant to grid frequency changes.

Clause 10: The method according to any one of clauses 1-9, wherein the first compensation is provided by a plant-level power feedback compensation based on a plant power feedback signal and the detected grid frequency.

Clause 11: The method according to any one of clauses 1-10, wherein the plant-level power feedback compensation is also based on an aggregated response estimation signal that predicts a collective response in active power of a group of the wind turbine generators in a plant to grid frequency changes.

Clause 12: The method according to any one of clauses 1-11, wherein the first compensation is provided by a signal derived from rate-of-change of the detected grid frequency applied to a plant power regulator in the plant level controller.

Clause 13: The method according to any one of clauses 1-12, wherein the first compensation is provided by one or more of: (a) a plant-level power command compensation based on the detected grid frequency; (b) a plant-level power feedback compensation based on a plant power feedback signal and the detected grid frequency; or (c) a signal derived from rate-of-change of detected grid frequency applied to a plant power regulator in the plant level controller.

Clause 14: A method for operating a wind turbine generator in a wind turbine plant having a plurality of wind turbines connected to a power grid, the wind turbines having a wind turbine controller in communication with a plant-level controller, the wind turbine generator having a power converter controller, the method comprising: operating the wind turbine generator in grid-forming mode (GFM) control; with the power converter controller, receiving a first control signal derived by the wind turbine controller based on a frequency droop function performed on a detected grid frequency; with the wind turbine controller, receiving a second control signal derived by the plant-level controller in part based on a frequency droop function performed on the detected grid frequency at the plant-level controller; with the power converter controller, generating an output power actuator signal based in part on an inertial power regulator or a frequency droop function performed on the detected grid frequency at the power converter controller; and applying a first compensation to the wind turbine controller, and applying a second compensation to the plant-level controller, wherein the first and second compensations reduce or eliminate changes in the control signal received by the power converter controller due to changes in the grid frequency.

Clause 15: The method according to clause 14, wherein the first compensation is provided by one or both of a turbine-level power command compensation based on the detected grid frequency or a turbine-level power feedback compensation based on a wind turbine power feedback signal and the detected grid frequency.

Clause 16: The method according to clause 14 or 15, wherein the second compensation comprises one or more of: (a) a plant-level power command compensation based on the detected grid frequency; (b) a plant-level power feedback compensation based on a plant power feedback signal and the detected grid frequency; or (c) a signal derived from rate-of-change of detected grid frequency applied to a plant power regulator in the plant level controller.

Clause 17: The method according to any one of clauses 14-16, wherein the plant-level power command compensation is also based on an aggregated response estimation signal that predicts a collective response in active power of a group of the wind turbine generators in a plant to grid frequency changes.

Clause 18: The method according to any one of clauses 14-17, wherein the plant-level power feedback compensation is also based on an aggregated response estimation signal that predicts a collective response in active power of a group of the wind turbine generators in a plant to grid frequency changes.

Clause 19: A wind turbine, comprising: a wind turbine generator configured as an inverter-based resource (IBR) renewable energy source connected to a power grid and controlled by a power converter controller; and wherein the wind turbine generator is configured for operation in accordance with the method according to any one of clauses 14-18.

Clause 20: A wind turbine plant, comprising: a plurality of wind turbines; each of the wind turbines comprising a wind turbine generator configured as an inverter-based resource (IBR) renewable energy source connected to a power grid and controlled by a power converter controller; and wherein the wind turbine generators are configured for operation in accordance with the method according to any one of clauses 14-18.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a renewable energy source having an inverter-based resource (IBR) system and controlled by a power converter controller, the method comprising:
operating the IBR system in grid-forming mode (GFM) control;
with the power converter controller, receiving a control signal that is derived based on a frequency droop function performed on a detected grid frequency at an upstream controller;
with the power converter controller, generating an output power actuator signal based on one of an inertial power regulator or frequency droop function performed on the detected grid frequency at the power converter controller; and
applying a first compensation to the upstream controller that reduces or eliminates changes in the control signal received by the power converter controller due to changes in the grid frequency or phase angle.

2. The method according to claim 1, wherein the IBR is a wind turbine generator, the upstream controller is a wind turbine controller, and the control signal received by the power converter controller is a power reference signal generated by the wind turbine controller.

3. The method according to claim 2, wherein the first compensation is provided by a turbine-level power command compensation based on the detected grid frequency.

4. The method according to claim 3, wherein the first compensation provided by the turbine-level power command compensation is also based on a generator rotor speed feedback signal.

5. The method according to claim 2, wherein the first compensation is provided by a turbine-level power or speed feedback compensation based on a wind turbine power feedback signal and the detected grid frequency.

6. The method according to claim 2, wherein the first compensation is provided by a turbine-level power command compensation based on the detected grid frequency and a turbine-level power feedback compensation based on a wind turbine power feedback signal and the detected grid frequency.

7. The method according to claim 1, wherein the IBR is a wind turbine generator and the control signal is a power reference signal generated by the wind turbine controller, wherein the upstream controller is a plant level controller that generates a power limit signal received by the wind turbine controller, the power limit signal used by the wind turbine controller to generate the power reference signal.

8. The method according to claim 7, wherein the first compensation is provided by a plant-level power command compensation based on the detected grid frequency.

9. The method according to claim 8, wherein the first compensation from the plant-level power command compensation is also based on an aggregated response estimation signal that predicts a collective response in active power of a group of the wind turbine generators in a plant to grid frequency changes.

10. The method according to claim 7, wherein the first compensation is provided by a plant-level power feedback compensation based on a plant power feedback signal and the detected grid frequency.

11. The method according to claim 10, wherein the first compensation from the plant-level power feedback compensation is also based on an aggregated response estimation signal that predicts a collective response in active power of a group of the wind turbine generators in a plant to grid frequency changes.

12. The method according to claim 7, wherein the first compensation is provided by a signal derived from rate-of-change of the detected grid frequency applied to a plant power regulator in the plant level controller to freeze the plant power regulator based on the rate-of-change of the detected grid frequency until the RoCoF signal is zero over a pre-defined period of time.

13. The method according to claim 7, wherein the first compensation is provided by one or more of: (a) a plant-level power command compensation based on the detected grid frequency; (b) a plant-level power feedback compensation based on a plant power feedback signal and the detected grid frequency; or (c) a signal derived from rate-of-change of detected grid frequency applied to a plant power regulator in the plant level controller.

14. A method for operating a wind turbine generator in a wind turbine plant having a plurality of wind turbines connected to a power grid, the wind turbines having a wind turbine controller in communication with a plant-level controller, the wind turbine generator having a power converter controller, the method comprising:
operating the wind turbine generator in grid-forming mode (GFM) control;
with the power converter controller, receiving a first control signal derived by the wind turbine controller based on a frequency droop function performed on a detected grid frequency;
with the wind turbine controller, receiving a second control signal derived by the plant-level controller in part based on a frequency droop function performed on the detected grid frequency at the plant-level controller;
with the power converter controller, generating an output power actuator signal based in part on an inertial power regulator or frequency droop function performed on the detected grid frequency at the power converter controller; and
applying a first compensation to the wind turbine controller, and applying a second compensation to the plant-level controller, wherein the first and second compensations reduce or eliminate changes in the control signal received by the power converter controller due to changes in the grid frequency.

15. The method according to claim 14, wherein the first compensation is provided by one or both of a turbine-level power command compensation based on the detected grid frequency or a turbine-level power feedback compensation based on a wind turbine power feedback signal and the detected grid frequency.

16. The method according to claim 14, wherein the second compensation comprises one or more of: (a) a plant-level power command compensation based on the detected grid frequency; (b) a plant-level power feedback compensation based on a plant power feedback signal and the detected grid frequency; or (c) a signal derived from rate-of-change of detected grid frequency applied to a plant power regulator in the plant level controller.

17. The method according to claim 16, wherein the plant-level power command compensation is also based on an aggregated response estimation signal that predicts a collective response in active power of a group of the wind turbine generators in a plant to grid frequency changes.

18. The method according to claim 16, wherein the plant-level power feedback compensation is also based on an aggregated response estimation signal that predicts a collective response in active power of a group of the wind turbine generators in a plant to grid frequency changes.

19. A wind turbine, comprising:
a wind turbine generator configured as an inverter-based resource (IBR) renewable energy source connected to a power grid and controlled by a power converter controller; and
wherein the wind turbine generator is configured for operation in accordance with the method according to claim 1.

20. A wind turbine plant, comprising:
a plurality of wind turbines;
each of the wind turbines comprising a wind turbine generator configured as an inverter-based resource (IBR) renewable energy source connected to a power grid and controlled by a power converter controller; and
wherein the wind turbine generators are configured for operation in accordance with the method according to claim 1.
